(19) United States
(12) Patent Application Publication
(10) Pub. No.: US 2002/0161819 A1
(43) Pub. Date: Oct. 31, 2002

(54) Environment assessment table, environment assessment apparatus, environment assessment system, server apparatus for environment assessment, terminal apparatus for enviroment assessment, auction system and program recording medium

(76) Inventors: Taeko Aoe, Nara (JP); Hiroshi Onishi, Osaka (JP)

Correspondence Address: Allan Ratner, Ratner & Prestia, Suite 301 One Westlakes Brewyn, PO Box 980, Valley Forge, PA, 19482-0980, US

(21) Appl. No.: 09/958,224

(22) PCT Filed: Feb. 2, 2001
(86) PCT No.: PCT/JP01/00738

(30) Foreign Application Priority Data
Feb. 7, 2000 (JP) 200029517

(51) Int. Cl. G06F 15/16

(52) U.S. Cl. 709/200

(57) ABSTRACT

An environment assessment table, has

an assessment item field containing predetermined assessment items about a plurality of types of targets of environment-related assessment;

an assessment standard field containing an assessment standard to determine assessment of respective assessment items; and

an assessment point field containing assessment points for various assessment result values determined by the assessment standard.

### TECHNICAL FIELD

The present invention relates to an environment assessment table, environment assessment apparatus, environment assessment system, and auction system and program recording medium to assess load imposed by a product on global resources and global environment.

### BACKGROUND ART

Sales of domestic appliances such as a TV set, a washing machine, an air-conditioner, and a refrigerator are growing year after year. The amount of manufacture of parts incorporated into these products such as motors, transformers, electronic parts, semiconductors and capacitors is also increasing year after year.

As the amount of manufacture grows, the amount of waste products also tends to grow and the issue of how to process or dispose of these waste products is becoming controversial.

Moreover, energy resources such as gases, electricity and petroleum and resources to become materials for products are not unlimited on the earth. Therefore, it is important to effectively use these resources.

There are also concerns about influences of emissions of carbon dioxide and toxic gases, etc. into the atmosphere, discharges into rivers and seas, disposal of discharges and solid waste into soil, etc.

In order to reduce such load on the global environment, influences of products in each lifecycle such as collection of resources for products, manufacture of raw materials, manufacture of products, circulation, sales, use, disposal/recycling have been investigated, predicted and assessed.

However, it is not easy to objectively and comprehensively grasp influences on the environment based on the above investigations, predictions and assessments about the environment. For example, when manufacturing one product, it is possible to individually estimate power required by a factory to manufacture the product and estimate the amount of substances contaminating the atmosphere produced when the product is disposed of, etc However, it is not easy to comprehensively grasp the load on such a variety of environments and assess the degree of load imposed on the environment as a whole.

That is, the problem is that it is not easy to objectively and comprehensively grasp influences of products on the environment.

Another problem is that even if there are still reusable parts in a product or part whose service life has reached the end, the product or part is often disposed of as waste, which means great load on the environment.

### DISCLOSURE OF INVENTION

It is an object of the present invention to provide an environment assessment table, environment assessment apparatus, environment assessment system, server apparatus for environment assessment, terminal apparatus for environment assessment, and program recording medium capable of objectively and comprehensively grasping influences of products on the environment taking into consideration the problems above.

It is another object of the present invention to provide an auction system and program recording medium capable of promoting recycling of a product or part whose service life has reached the end and reducing load on the environment.

The 1^{st} invention of the present invention (corresponding to claim 1) is an environment assessment table, comprising:

an assessment item field containing predetermined assessment items about a plurality of types of targets of environment-related assessment;

an assessment standard field containing an assessment standard to determine assessment of respective assessment items; and

an assessment point field containing assessment points for various assessment result values determined by said assessment standard.

The 2^{nd} invention of the present invention(corresponding to claim 2) is the environment assessment table according to 1^{st} invention, wherein said table is provided in a sheet form or whole or part of which can be displayed in a display apparatus and has a blank field that can contain specific numerical values in said assessment standard field about specific targets to be assessed, assessment result values and assessment points obtained in said assessment point field in whole or in part, and said blank field is writable.

The 3^{rd} invention of the present invention(corresponding to claim 3) is the environment assessment table according to 1^{st} or 2^{nd} inventions, wherein when said environment assessment table is displayed on said display apparatus, restrictions are placed on the display content and the content of said table in whole or in part is displayed according to the authority of a person who displays the table.

The 4^{th} invention of the present invention(corresponding to claim 4) is the environment assessment table according to any one of 1^{st} to 3^{rd} inventions, wherein said assessment item field is classified into at least a product body, production process and packing.

The 5^{th} invention of the present invention(corresponding to claim 5) is the environment assessment table according to any one of 1^{st} to 4^{th} inventions, wherein basic data and/or a basic assessment method presupposed to determine said assessment standard are also added.

The 6^{th} invention of the present invention(corresponding to claim 6) is the environment assessment table according to any one of 1^{st} to 5^{th} inventions, wherein said assessment item field contains at least transport assessment during transportation of said target and usage assessment when said target is used and has a field for calculating assessment values over the lifecycle of said target from the assessment values in whole or in part of said assessment item field.

The 7^{th} invention of the present invention(corresponding to claim 7) is an environment assessment apparatus for using one or a plurality of environment assessment tables according to 1^{st} to 6^{th} inventions, performing assessment on a specific assessment target based on said assessment standard and obtain assessment points from the assessment results, comprising:

assessment standard inputting means of inputting data to calculate said assessment standard for a specific assessment target;

assessment outputting means of assessing said assessment standard and outputting the assessment result using said tables based on the data input by said assessment standard inputting means;

assessment point calculating means of obtaining assessment points from said assessment outputting means using said tables; and

assessment point outputting means of outputting assessment points obtained by said assessment point calculating means.

The 8^{th} invention of the present invention(corresponding to claim 8) is the environment assessment apparatus according to 7^{th} invention, wherein said assessment standard inputting means can enter data to calculate said assessment standard from a parts list and/or design drawings of said target.

The 9^{th} invention of the present invention(corresponding to claim 9) is an environment assessment system equipped with a plurality of terminals mutually connected over a network and a single or a plurality of servers connected to the network,

wherein each of said terminals comprises:

calculating means of calculating points of assessment on a predetermined target using the environment assessment table according to any one of 1^{st} to 6^{th} inventions; and

outputting means of outputting assessment points for said target to a predetermined server from among said servers from the calculation result of the calculating means,

and said server accumulates the environment assessment information obtained.

The 10^{th} invention of the present invention (corresponding to claim 10)is the environment assessment system according to 9^{th} invention, wherein said server supplies said environment assessment table to each terminal and also additionally supplies basic data and/or basic assessment method presupposed to determine said assessment standard to each of said terminals.

The 11^{th} invention of the present invention (corresponding to claim 11) is the environment assessment system according to 9^{th} or 10^{th} inventions, herein said terminal sends information to determine said assessment standard to another terminal using said basic data and/or basic assessment method and said other terminal performs assessment based on said environment assessment table using the information.

The 12^{th} invention of the present invention (corresponding to claim 12) is the environment assessment system according to any one of 9^{th} to 11^{th} inventions, wherein said terminal can modify, add or delete the content of said environment assessment table received from said server.

The 13^{th} invention of the present invention (corresponding to claim 13) is the environment assessment system according to any one of 9^{th} to 12^{th} inventions, wherein the data accumulated in said server is stratified and accessible layers vary depending on the level of the right of access to the data.

The 14^{th} invention of the present invention (corresponding to claim 14) is the environment assessment system according to any one of 9^{th} to 13^{th} inventions, wherein said terminal comprises assessment standard inputting means of inputting data to calculate said assessment standard from said target parts list and/or design drawings and said calculating means calculates said assessment points using said input data.

The 15^{th} invention of the present invention (corresponding to claim 15) is a terminal apparatus for environment assessment connected to a network, comprising:

calculating means of calculating assessment points for a predetermined target using the environment assessment table according to any one of 1^{st} to 6^{th} inventions; and

outputting means of outputting assessment points for said target to said network from the calculation result from said calculating means.

The 16^{th} invention of the present invention (corresponding to claim 16) is a server apparatus for environment assessment that accumulates at least the assessment points output to a network by a plurality of terminal apparatuses for environment assessment according to 15^{th} invention as environment assessment information.

The 17^{th} invention of the present invention(corresponding to claim 17) is an auction system, comprising:

a plurality of terminals connected to a network; and

a server connected to said network,

wherein said terminal supplies said server with information of recycled materials or used products or used materials to be supplied to an auction and auction conditions thereof, and

said server collects information of recycled materials or used products or used materials sent from said terminal, puts these products for auction according to said auction conditions and then notifies said participating terminal of the result.

The 18^{th} invention of the present invention is (corresponding to claim 18) the auction system according to 17^{th} invention, wherein said information of recycled materials or used products or used materials also includes information obtained from the environment assessment apparatus according to 7^{th} invention.

The 19^{th} invention of the present invention (corresponding to claim 19) is the auction system according to 18^{th} invention, wherein said terminal participating in auction needs to be registered beforehand and commissions vary depending on the type of terminal.

The 20^{th} invention of the present invention (corresponding to claim 20) is the auction system according to any one of 17^{th} to 19^{th} inventions, wherein said terminal supplies information of recycled materials or used products or used materials to be supplied to said auction and a plurality of auction conditions thereof.

The 21^{st} invention of the present invention (corresponding to claim 20) is the auction system according to any one of 17^{th} to 20^{th} inventions, wherein said terminal offers said plurality of auction conditions with priority assigned beforehand and when no buyer is found within a predetermined time presented under said auction conditions, changes to said auction condition with lower priority.

The 22^{nd} invention of the present invention (corresponding to claim 22) is the auction system according to any one of 17^{th} to 21^{st} inventions, wherein said terminal offers said auction conditions with priority assigned to each item of said auction conditions,

said server, when an auction is held, assesses conditions presented by terminals to be a buyer with weights assigned according to the priority of said each item of said auction conditions, calculates priority of the terminals to be a buyer and determines whether any one of said terminals participating in said auction has the advantage over other terminals as a buyer.

The 23^{rd} invention of the present invention (corresponding to claim 23) is the auction system according to 22^{nd} invention, wherein said priority means points and said advantage means the total points of assessment result value obtained by assessment for every said item.

The 24^{th} invention of the present invention(corresponding to claim 24) is a program recording medium that records a program and/or data to allow a computer to execute all or some functions of all or some means of the environment assessment table, environment assessment apparatus, environment assessment system, environment assessment server apparatus, environment assessment terminal apparatus or auction system according to any one of 7^{th} to 23^{rd} inventions, wherein said program recording medium is computer-readable.

The 25^{th} invention of the present invention (corresponding to claim 25) is a program that allows a computer to execute all or some functions of all or some means of the environment assessment table, environment assessment apparatus, environment assessment system, environment assessment server apparatus, environment assessment terminal apparatus or auction system according to any one of 7^{th} to 23^{rd} inventions.

### BRIEF DESCRIPTION OF DRAWINGS

FIGS. 1-1, 1-2, 1-3 is a figure showing an environment assessment table according to a first and second embodiments of the present invention.

FIG. 2A is a figure showing energy consumption (crude oil equivalent), which is an example of a basic assessment method according to the first and second embodiments of the present invention.

FIG. 2B is a figure showing the amount of CO₂ discharged (C equivalent value), which is an example of the basic assessment method according to the first and second embodiments of the present invention.

FIG. 2C is a figure showing a heating value by the type of energy and original unit of discharge by the type of energy, which is an example of basic data according to the first and second embodiments of the present invention.

FIG. 3 is a block diagram showing a configuration of an environment assessment apparatus according to the first embodiment of the present invention.

FIG. 4 is a figure showing a configuration of an environment assessment system according to the second embodiment of the present invention.

FIG. 5 is a figure showing a configuration of a server according to the second embodiment of the present invention.

FIG. 6 is a figure showing a configuration of a terminal according to the second embodiment of the present invention.

FIG. 7 is a figure showing a configuration of an auction system according to a third embodiment of the present invention.

FIG. 8 is a figure showing a configuration of a server according to the third embodiment of the present invention.

FIG. 9 is a figure showing a configuration of a terminal according to the third embodiment of the present invention.

FIG. 10 is a figure showing seller information according to the third embodiment of the present invention.

FIG. 11A is a figure showing an example of auction conditions according to the third embodiment of the present invention.

FIG. 11B is a figure to explain a method of determining priority of buyers according to the third embodiment of the present invention.

### DESCRIPTION OF SYMBOLS

1 Environment assessment table

2 Assessment item

3 Assessment standard

4 Weight

5 Assessment point standard

6 Standard product

7 Target

8 Intermediate assessment

9 Final assessment

10 Points

11 Usage rate of recycled materials

13 Energy reduction rate

14 CO₂ reduction rate

16 Product body segment assessment

17 Production segment assessment

18 Packing segment assessment

19 Environment assessment apparatus

20 Data inputting means

21 Assessment outputting means

22 Assessment point calculating means

23 Assessment point outputting means

24 Network

25 Server

26 Terminal

27 Terminal

28 Terminal

29 Environment assessment system

30 Basic data

31 Basic assessment method

32 Environment assessment information

33 Data inputting means

34 Calculating means

35 Outputting means

36 Editing means

40 Head office

41 Business establishment

42 Parts supply company

43 Basic assessment data

44 Basic assessment method

45 Basic assessment method

46 Basic assessment data

51 Network

53 To 55 terminals

66 Auction conditions

67 Product or parts information

68 Seller information

### BEST MODE FOR CARRYING OUT THE INVENTION

With reference now to the attached drawings, embodiments of the present invention will be explained below.

(First Embodiment)

First, a first embodiment will be explained.

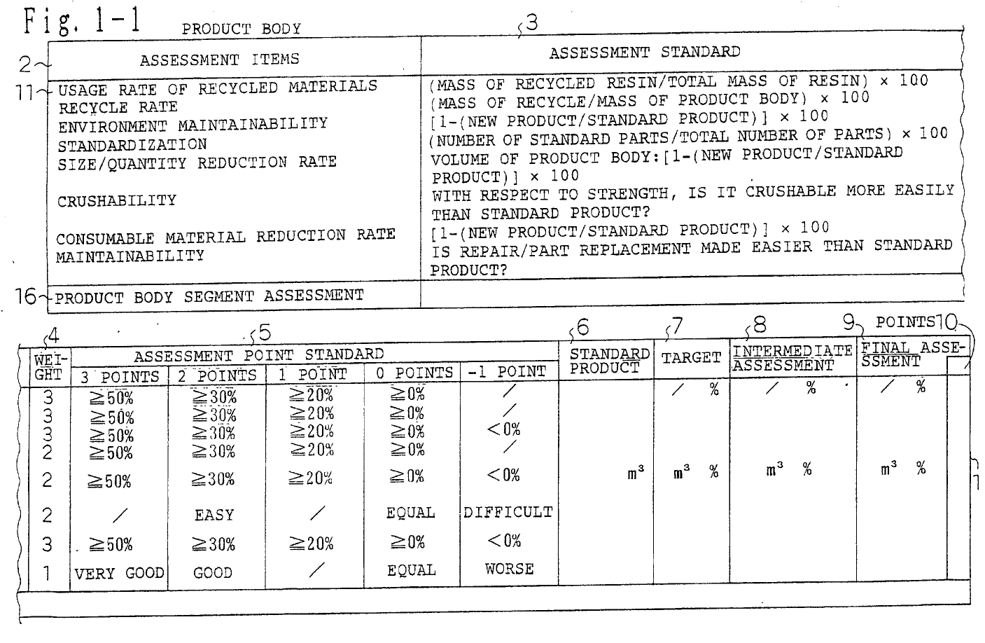

FIGS. 1-1, 1-2, 1-3 shows an environment assessment table 1.

The environment assessment table 1 is provided in a sheet form such as paper or plastic sheet.

The environment assessment table 1 is provided for each of a plurality of types of assessment target on environment such as a TV set, washing machine, air-conditioner, refrigerator, motor, transformer, chip resistor, semiconductor, capacitor, etc.

The field of assessment items 2 is the field containing assessment items such as usage rate of recycled materials 11.

The field of assessment standard 3 is the field containing standard to carry out assessment on each of assessment items 2. For example, the assessment standard 3 when the assessment items 2 is usage rate of recycled materials 11 is “(mass of recycled resin/total mass of resin)×100.” The meaning of typical assessment standard 3 will be described later.

Assessment point standard 5 is the field containing assessment points corresponding to values of results of various assessments determined by the assessment standard 3.

Weight 4 is the field indicating weighting factors for the assessment point standard 5. The weight 4 is assigned to items as 3, 2 and 1 in descending order of estimated importance.

That is, the final evaluation point of the assessment items 2 is calculated in the following Equation 1.

Final assessment point=weight×point of assessment point standard [Equation 1]

For example, in the case where the assessment result value determined by the assessment standard 3 of the usage rate of recycled materials 11 is 35%, the final assessment point of usage rate of recycled materials 10 is 3×2 points=6 points.

When data on a product to be set as a standard is required to calculate an assessment value by the assessment standard 3, standard product 6 is the field containing the data.

Target 7 is the field to enter a target value about important assessment items 2 in planning/design stage, etc.

Intermediate assessment 8 is the field to enter intermediate assessment carried out in final preproduction stage, etc. The intermediate assessment 8 is carried out in a plurality of stages as required. In this case, a plurality of fields of intermediate assessment 8 is provided.

Final assessment 9 is the field to enter final assessment carried out in volume preproduction, etc.

Points 10 is the field to enter a final assessment point calculated based on the aforementioned Equation 1 when the final assessment 9 is carried out.

Furthermore, the assessment items 2 of the environment assessment table 1 is classified into the “product body,” which is assessment related to the assessment target itself, “production process,” which is assessment related to production of the assessment target and “packing,” which is assessment related to packing of the assessment target. In addition to this, though not illustrated in FIGS. 1-1, 1-2, 1-3, the assessment items 2 is further classified into “usage assessment,” which is assessment when the assessment target is used and “transport assessment,” which is assessment when the assessment target is transported.

FIGS. 1-1, 1-2, 1-3 shows only part of the assessment items 2 to facilitate understanding. Actually, there are many assessment items 2 in addition to those shown in FIGS. 1-1, 1-2, 1-3. That is, the assessment items 2 include items to assess load on the environment over the lifecycle of a product from collection of resources through manufacture of raw materials, manufacture of product, circulation, sales, use, down to disposal/recycling of the product. Therefore, it is possible to assess environmental load throughout the lifecycle of the product.

Product body segment assessment 16 is the field to enter overall assessment of items categorized as the product body from among the assessment items 2. The overall assessment of items categorized as the product body is a value obtained by multiplying the sum total of points 10 of the assessment items 2 categorized as the product body by a predetermined weighting factor.

Production segment assessment 17 is the field to enter overall assessment of items categorized as the production process from among the assessment items 2. The overall assessment of items categorized as the product process is a value obtained by multiplying the sum total of points 10 of the assessment items 2 categorized as the production process by a predetermined weighting factor.

Packing segment assessment 18 is the field to enter overall assessment of items categorized as packing from among the assessment items 2. The overall assessment of items categorized as packing is a value obtained by multiplying the sum total of points 10 of the assessment items 2 categorized as packing by a predetermined weighting factor.

Likewise, though not illustrated in FIGS. 1-1, 1-2, 1-3, fields to enter overall assessment of the assessment items 2 categorized as “usage assessment” and “transport assessment” are also provided. Furthermore, a field to enter a value of overall assessment over the entire lifecycle of the assessment target from the overall assessment for each category above is also provided. That is, the overall assessment value over the entire lifecycle is assumed to be the sum total of the overall assessment values of respective categories.

The environment assessment table 1 also contains information such as basic data presupposed to obtain assessment values according to the assessment standard 3 and basic assessment method.

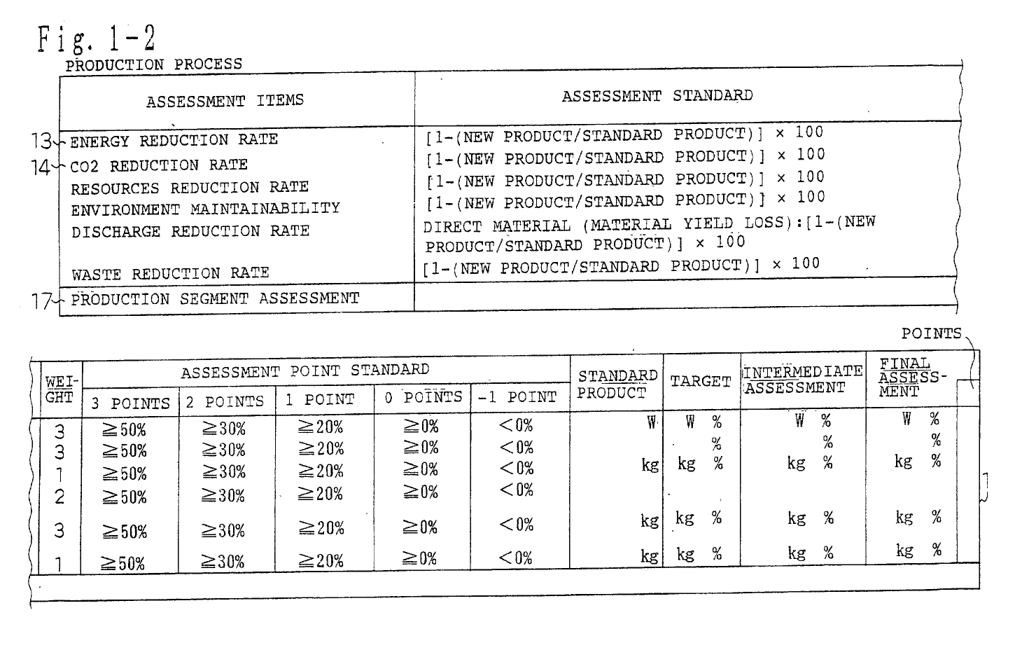

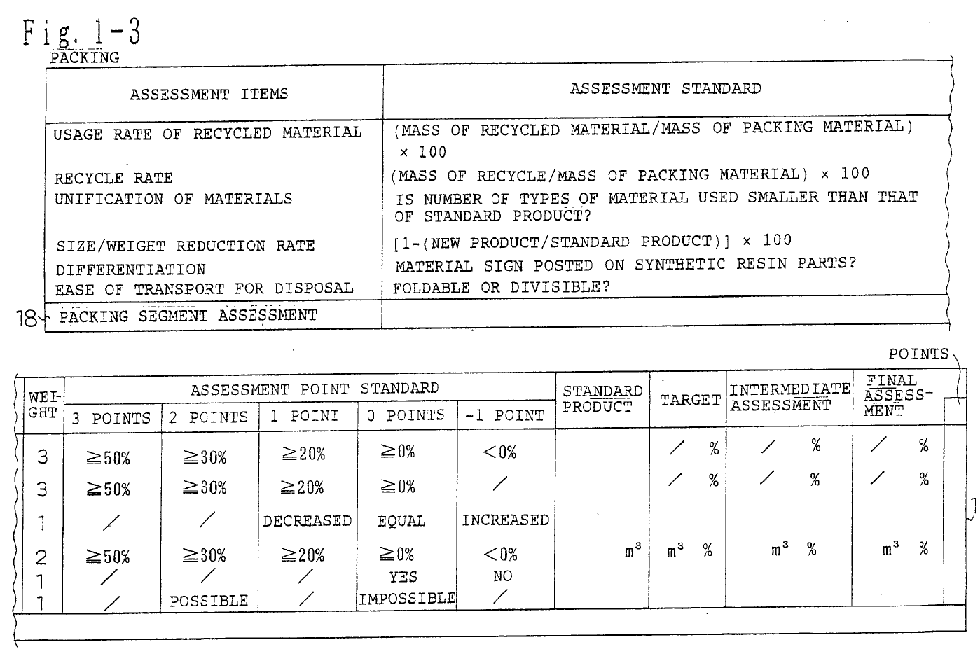

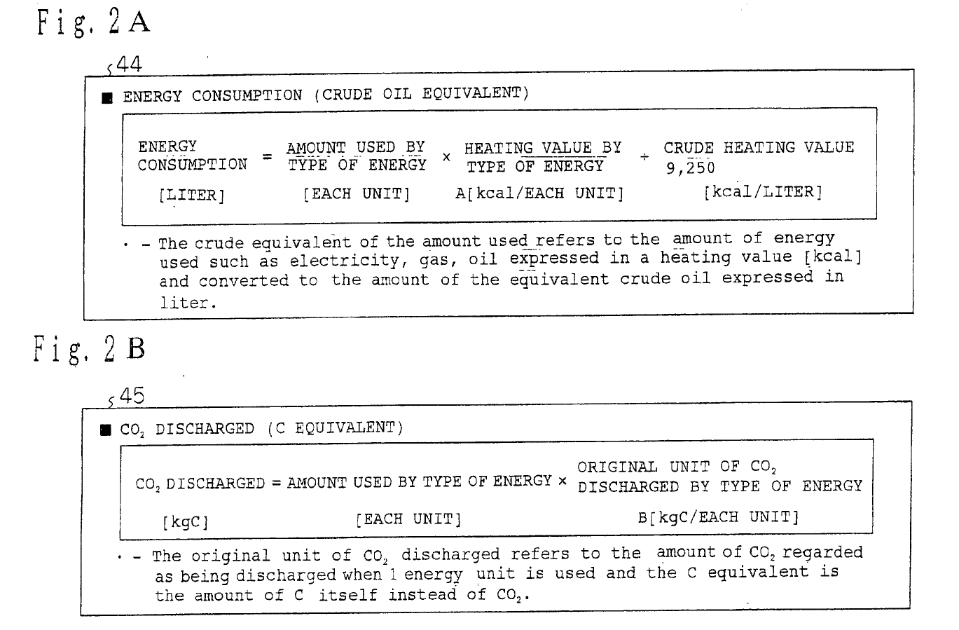

FIG. 2 shows examples of such basic assessment data and basic assessment method.

FIGS. 2A, 2B and 2C show basic assessment method 44 and basic assessment method 45, which are examples of basic assessment method, and basic assessment data 46, which is an example of basic assessment data. These figures show the calculation expressions to calculate the crude oil equivalent of the amount of use by the type of energy and the amount of CO₂ discharged basic data used for calculations using these calculation expressions. FIG. 2 will be explained in detail later.

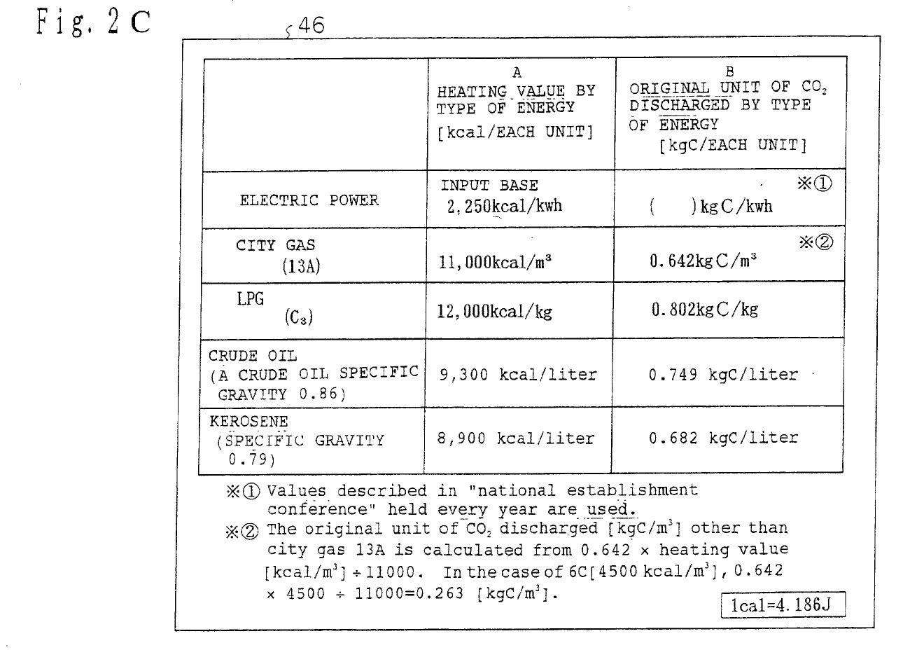

FIG. 3 shows a configuration of an environment assessment apparatus 19 that performs environment assessment using such an environment assessment table 1.

The environment assessment apparatus 19 is configured by data inputting means 20, assessment outputting means 21, assessment point calculating means 22, assessment point outputting means 23 and environment assessment table 1.

The data inputting means 20 is the means to enter data to calculate the assessment standard 3 with respect to a specific assessment target.

That is, the data inputting means 20 can incorporate parts list/design drawings 37 which are information on parts and materials making up the specific assessment target, and information described in design drawings created by CAD, etc. in a CSV (comma separated value) format, etc. and automatically input data to calculate the assessment standard 3.

The assessment outputting means 21 is the means of outputting the assessment result value of the assessment standard 3 based on the data entered from the data inputting means 20 using the environment assessment table 1.

The assessment point calculating means 22 is the means of calculating from the assessment result value above the points 10, which is the final assessment point and further calculating product body segment assessment 16, production segment assessment 17, packing segment assessment 18, overall assessment of usage assessment, overall assessment of transport assessment and overall assessment of the whole.

The assessment point outputting means 23 is the means of outputting the assessment points obtained by the assessment point calculating means 22. Furthermore, the assessment point outputting means 23 can also display the environment assessment table 1 in whole or in part on a monitor, which is not shown, or print on paper sheets.

The items entered in the field of assessment items 2 such as usage rate of recycled materials 11, recycle rate and environment maintainability, etc. of this embodiment are examples of predetermined assessment items of the present invention, the items entered in the field of assessment standard 3 such as “(mass of recycled resin/total mass of resin)×100” are examples of the assessment standard of the present invention, items entered in the fields of weight 4 and assessment point standard 5 are examples of the assessment point field of the present invention, items in the fields of standard product 6, target 7, intermediate assessment 8, final assessment 9, points 10 are examples of the blank field of the present invention, a numerical value related to the standard product in the field of standard product 6, numerical values to calculate the assessment standard 3 entered in the fields of target 7, intermediate assessment 8 and final assessment 9 are examples of specific numerical values of the present invention, the result values of the assessment standard 3 entered in the fields of target 7, intermediate assessment 8 and final assessment 9 are examples of the assessment result values of the present invention and a numerical value entered in the field of points 10 is an example of assessment point of the present invention.

The data inputting means 20 of this embodiment is an example of the assessment standard inputting means of the present invention.

Next, operation of this embodiment will be explained.

First, the assessment target is determined. As the assessment target, for example, suppose a TV set of product number ABC 123 is assessed. Furthermore, suppose the TV set of product number XYZ 789 is standard data. Also, suppose final assessment 9 is performed.

The data inputting means 20 enters data of the standard product 6 about the item that requires the data of standard product 6 of the assessment standard 3.

That is, the data inputting means 20 incorporates parts list/design drawings 37 which is information on parts and materials making up the specific assessment target, and information described in design drawings created by CAD, etc. in a (CSV (comma separated value) format, etc. and automatically enters data of the standard product 6 without human intervention.

Here, the CSV format is a format to convert data created by a spreadsheet program or database software, etc.

The data of the standard product 6 is written in the environment assessment table 1.

For example, in energy reduction rate 13, obtaining an assessment standard result value requires the value of amount of energy necessary to produce a standard product. Therefore, the value of amount of energy necessary to produce a TV set of product number XYZ 789 is entered beforehand.

Next, the data inputting means 20 enters data necessary to calculate the assessment standard result value of the assessment standard 3.

That is, the inputting means 20 incorporates the parts list/design drawings 37 in a CSV format and automatically enters data necessary to calculate the assessment standard result value of the assessment standard 3 without human intervention.

For example, in the case of usage rate of recycled materials 11, the total mass of resin of the TV set of product number ABC 123 and the mass of recycled resin thereof are entered.

The data necessary to calculate an assessment standard result value such as the mass of recycled resin and total mass of resin is written in the field of final assessment 9 of the environment assessment table 1.

As shown above, with respect to the TV set of product number ABC 123 in each of assessment items 2, data necessary to calculate an assessment standard result value of the assessment standard 3 is entered.

Then, the assessment outputting means 21 calculates each assessment standard result value from each assessment standard 3 using the environment assessment table 1.

Each assessment standard result value calculated is written in the field of final assessment 9 of the environment assessment table 1.

Furthermore, the assessment point calculating means 22 calculates an assessment point using each assessment standard result value calculated, assessment point standard 5 and weight 4. Furthermore, overall assessment points of different categories such as product body segment assessment 16, production segment assessment 17 and packing segment assessment 18 are calculated and the overall assessment value over the lifecycle of the TV of product number ABCG 123 is calculated.

For example, in the case of usage rate of recycled materials 11, suppose the assessment standard result value is 35%. The assessment point using Equation 1 is 3×2 points=6 points.

The assessment points calculated in this way are written in the field of points 10 and the overall assessment points of different categories such as product body segment assessment 16, production segment assessment 17, packing segment assessment 18 are written in the fields of product body segment assessment 16, production segment assessment 17 and packing segment assessment 18. Then, the overall assessment value over the lifecycle is also written in the environment assessment table 1.

Finally, the assessment point outputting means 23 outputs the updated environment assessment table 1 in whole or in part or only assessment points according to the user's specification.

Then, as described above, typical items of the assessment items 2 will be explained in detail.

First, the usage rate of recycled materials 11 will be explained.

The assessment standard 3 of the usage rate of recycled materials 11 is “(mass of recycled resin/total mass of resin)×100.” That is, this indicates the percentage of the mass of resin obtained by reworking a used material with respect to the total mass of resin. If this value is assumed to be 35%, 3×2 points=6 points is written in the field of points 10, which is the final assessment point.

Then, the energy reduction rate 13 and CO₂ reduction rate 14 will be explained together.

The assessment standard of the energy reduction rate 13 is “[1−(new product/standard product)]×100” and the assessment standard of CO₂ reduction rate 14 is also “[1−(new product/standard product)]×100.”

In these items, assessment standard result values are calculated using the basics data 46 and basic assessment methods 44 and 45 as shown in FIG. 2. The basic assessment method 44 in FIG. 2A describes a basic assessment method, which expresses energy consumption with the crude oil equivalent and the basic assessment method 45 in FIG. 2B describes a basic assessment method, which expresses the amount of CO₂ discharged with the C equivalent. Furthermore, the basic assessment data 46 in FIG. 2C. describes basic data of the heating value by the type of energy and original unit of CO₂ discharged by the type of energy.

Energy reduction rate 13 and CO₂ reduction rate 14 calculate assessment standard result values using these basic assessment method and basic data.

An example of the assessment items 2 classified as transport assessment is CO₂ reduction rate. This indicates how much CO₂ discharged for transport is reduced relative to a standard product over the lifecycle of a product. Basic data to obtain such CO₂ reduction is “Product is transported by 1000 Km at a time by a 4 t truck,” etc. Using this basic data as a premise, the assessment result value Of CO₂ reduction rate is obtained.

An example of the assessment items 2 classified as usage assessment is energy reduction rate. This indicates how much energy consumption during use of a product is reduced relative to a standard product. Basic data to calculate such an energy reduction rate in the case where the assessment target is a TV set is “TV set is used for 4.5 hours a day and put on standby for 19.5 hours,” etc. Using this basic data as a premise, an assessment result value of the reduction rate of energy consumption while the product is in use is calculated.

As described above, the environment assessment apparatus 19 of this embodiment carries out environment assessment. The environment assessment result is quantified in a form of points by the assessment item and type of the assessment item over the entire lifecycle. Therefore, it is possible to objectively and comprehensively grasp influences of a product on the environment.

Then, by changing the design of the assessment target and production method as required as in the case where the assessment point is lower than a target value, it is possible to reduce environment load.

By the way, the environment assessment apparatus 19 of this embodiment has been described assuming that final assessment 9 is conducted, but intermediate assessment 8 can also be conducted in the same way. When conducting intermediate assessment 8, it is possible not to calculate assessment points and calculate assessment points by adding a field for entering assessment points in the field of intermediate assessment 8 of the environment assessment table 1 as in the case of the field of final assessment 9.

Furthermore, in addition to the fields of standard product 6, target 7, intermediate assessment 8 and final assessment 9, the environment assessment table 1 of this embodiment can also include other items. There is no problem even if fields like intermediate assessment 8 and target 7 are not included.

Furthermore, the numerical values entered in the field of weight 4 of the environment assessment table 1 of this embodiment are not fixed, and all that is required is to determine the values taking into consideration various circumstances of the country, region or office in which environment assessment is performed.

Furthermore, the standard entered in the field of assessment point standard 5 of the environment assessment table 1 of this embodiment is not fixed, and all that is required is to determine the standard taking into consideration various circumstances of the country, region or office in which environment assessment is performed.

Furthermore, this embodiment describes the case where weight 4 of the environment assessment table 1 consists of 3 stages of 1, 2 and 3, but weight 4 can consist of 2 stages or 4 stages, etc as far as weight 4 represents a predetermined number of coefficients.

Furthermore, this embodiment describes the case where the field of assessment point standard is divided into 5 areas, but the present invention is not limited to this and there can be 4 or 7 areas, etc. as far as this field is divided into a predetermined number of areas.

Furthermore, this embodiment describes the case where the data inputting means 20 incorporates parts list/design drawings 37 in a CSV format, etc. and automatically enters data necessary to calculate data of standard product 6 and assessment standard result value of the assessment standard 3 without human intervention, but the present invention is not limited to this. It is also possible for the data inputting means 20 to display a GUI screen on a monitor and for the user to enter data necessary to calculate data of the standard product 6 and assessment standard result value of the assessment standard 3 using a keyboard or mouse.

(Second Embodiment)

Then, a second embodiment will be explained.

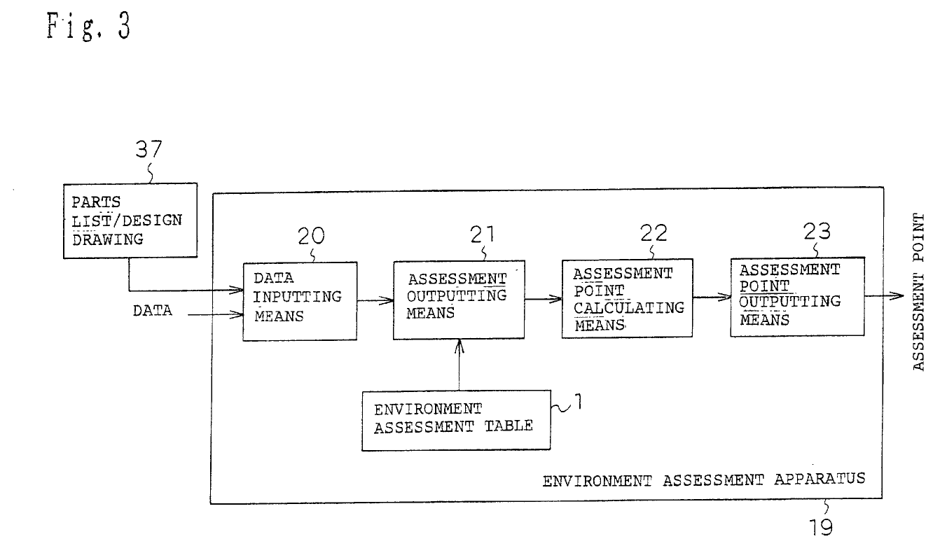

FIG. 4 shows a configuration of an environment assessment system 29 of this embodiment.

The environment assessment system 29 comprises a network 24 with a server 25 and a plurality of terminals 26, 27 and 28 connected thereto. The terminal 26 is connected to a head office 40, the terminal 27 is installed in a business establishment 41 that manufactures assessment target products, the terminal 28 is installed in a parts supply company 42 that manufactures assessment target parts and supplies these parts to the business establishment 41. The terminal 28 is under the control of the terminal 27. To facilitate the understanding, FIG. 4 shows a case where three terminals 26 to 28 are connected to the network 24, but actually the number of terminals 26 to 28 is not limited to 3 and these terminals are installed in a plurality of business establishments and a plurality of parts supply companies.

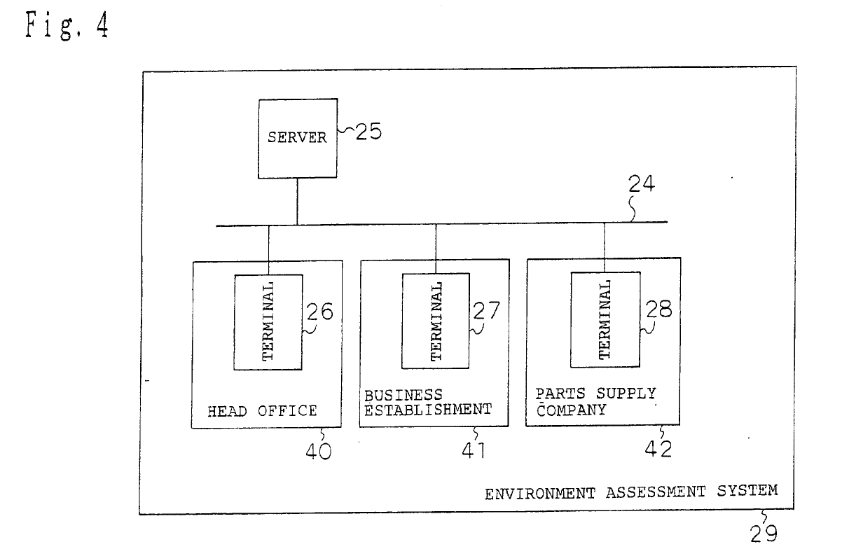

FIG. 5 shows a configuration of the server 25. The server 25 supplies an environment assessment table 1, basic data 30 and basic assessment method 31 to the terminals 26 and 27 and also functions as a server in a client server system that stores environment assessment information 32 sent from the terminals 26 and 27. The environment assessment table 1, basic data 30 and basic assessment method 31 stored in the server 25 are hierarchically controlled for deep layers and for external use. etc. Then, in order to access data in a deep layer from the terminal 26, etc., it is necessary to enter a password to show that the user has the access right in the terminal 26 and acquire access permission. Furthermore, in order to access data that belongs to the layer for external use, it is necessary to enter a password showing that the user has the right to access the data.

The environment assessment table 1, basic data 30, basic assessment method 31 and parts list/design drawings 37 are the same as those described in the first embodiment.

Furthermore, the environment assessment information 32 is information on the result of assessment carried out on assessment targets.

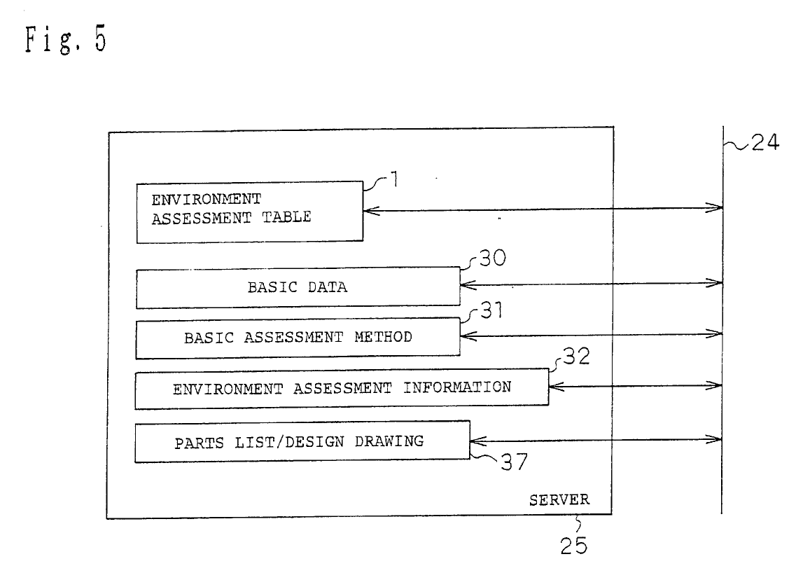

FIG. 6 shows a configuration of the terminal 26. The terminal 26 is a client in a client server system. The terminal 26 is configured by data inputting means 33, calculating means 34, outputting means 35 and editing means 36.

The data inputting means 33 is means of entering data to calculate assessment standard 3 on a specific assessment target.

The calculating means 34 is means of calculating the assessment result value of the assessment standard 3 of the environment assessment table 1 based on the data entered from the data inputting means 33 using the environment assessment table 1, basic data 30 and basic assessment method 31, calculating points 10, which is the final assessment point, from the assessment result value and further calculating overall assessment of the product body segment assessment 16, production segment assessment 17, packing segment assessment 18, overall assessment of usage assessment, overall assessment of transport assessment and overall assessment of the whole, that is, assessment points over the lifecycle of the assessment target.

The outputting means 35 is means of outputting assessment points obtained from the calculating means 34 together with information to specify the assessment target to the network. Furthermore, the outputting means 35 can also display the environment assessment table 1 in whole or in part on a monitor, which is not shown, or print on paper sheets.

The editing means 36 is means of modifying, adding or deleting the content of the environment assessment table 1.

Furthermore, the configurations of the terminal 27 and terminal 28 are the same as that of the terminal 26.

The terminals 26, 27 and 28 are examples of the terminals of the present invention and the terminals 26, 27 and 28 are also examples of the environment assessment terminal apparatus of the present invention. Furthermore, the server 25 of this embodiment is an example of the server of the present invention and the server 25 of this embodiment is also an example of the server apparatus for environment assessment of the present invention.

Next, operation of this embodiment will be explained below.

First, operation of maintenance of data such as the environment assessment table 1 stored in the sever will be explained.

The user who has the manager authority of the environment assessment system 29 performs maintenance of the environment assessment table 1, basic data 30, basic assessment method 31 and environment assessment information 32 from the terminal 26 installed in the head office 40.

Such maintenance can be performed by the user entering a manager password to the terminal 26. That is, when the user enters the manager password to the terminal 26, the terminal 26 allows the user to modify, add or delete the environment assessment table 1, basic data 30, basic assessment method 31 and environment assessment information 32.

The terminal 26 requests the server 25 to transfer parts necessary for maintenance of the environment assessment table 1, basic data 30, basic assessment method 31 and environment assessment information 32 stored in the server 25 based on an instruction from the user.

In response to this, the server 25 transfers the parts necessary for maintenance to the terminal 26.

The parts transferred are displayed by the editing means 36 on a monitor. Then, the user performs maintenance on these data using a GUI of the editing means 36.

When maintenance is completed, the terminal 26 transfers the parts subjected to maintenance to the server 25.

As an example of such maintenance, for example, a gasoline heating value and original unit of CO₂ discharged are added to the basic assessment data 46 in FIG. 2C, which is the basic data 30.

There is also a case where a product used as the standard product 6 is changed to another standard product 6 because the function or production method becomes obsolete over time. In this case, the data of the standard product 6 of the assessment standard 3 of the environment assessment table 1 is modified.

Then, operation of the terminal 27 of the business establishment 41 when assessing an assessment target will be explained.

First, an assessment target will be determined. As the assessment target, suppose for example, a TV set of product number of ABC 123 is assessed as in the case of the first embodiment. Furthermore, suppose the TV set of product number XYZ 789 is a standard product. However, the data on the standard product is already described in the environment assessment table 1 as described in the maintenance operation.

The user enters a password for the business establishment assessor to the terminal 27.

The terminal 27 checks the password entered and when the password is proven to be the correct one, the terminal 27 allows the user to perform assessment.

The data inputting means 33 of the terminal 27 enters the product number of a TV set, which is the assessment target, first. That is, the data inputting means 33 enters the product number ABC 123.

Then, the terminal 27 notifies the server 25 of the product number of the product to be assessed and requests the server 25 to transfer the environment assessment table 1 to be used to assess the TV set of product number ABC 123 and basic data 30, basic assessment method 31 and parts list/design drawings 37 to calculate the result value of the assessment standard 3 of the environment assessment table 1.

In response to this, the server 25 transfers the environment assessment table 1 of the TV set of product number ABC 123, basic data 30, basic assessment method 31 and parts list/design drawings 37 to the terminal 27.

Then, the data inputting means 33 of the terminal 27 automatically enters data necessary to calculate the assessment standard result value of the assessment standard 3 from the parts list/design drawings 37 as in the case of the first embodiment.

Then, the data necessary to calculate the assessment standard result value is written in the field of the final assessment 9 of the environment assessment table 1.

In this way, data necessary to calculate the assessment standard result value of the assessment standard 3 about the TV set of product number ABC 123 in each of assessment items 2 is entered.

Then, the calculating means 34 of the terminal 27 calculates each assessment standard result value from the assessment standard 3 using the environment assessment-table 1.

Each assessment standard result value obtained is written in the field of the final assessment 9 of the environment assessment table 1.

Furthermore, the calculating means 34 calculates assessment points using each assessment standard result value obtained and assessment point standard 5 and weight 4. Furthermore, the calculating means 34 calculates overall assessment points of different categories such as product body segment assessment 16, production segment assessment 17, packing segment assessment 18, etc. and calculates an overall assessment value over the lifecycle of the TV set of product number ABC 123.

For example, in the case of usage rate of recycled materials 11, if the assessment standard result value is 35%, the assessment point is calculated using the Equation 1 as: 3×2 points=6 points.

The assessment point obtained in this way is written in the field of points 10 and the overall assessment points of different categories such as product body segment assessment 16, production segment assessment 17 and packing segment assessment 18 are written in the fields of product body segment assessment 16, production segment assessment 17 and packing segment assessment 18, respectively. Then, the overall assessment value over the lifecycle is also written in the environment assessment table 1.

Finally, the outputting means 35 displays the updated environment assessment table 1 in whole or in part or only assessment points on the monitor of the terminal 27 according to the user's specification and at the same time transfers to the server 25 via the network 24.

The server 25 stores the assessment result transferred from the terminal 27 as the environment assessment information 32.

Then, operation of the terminal 28 installed in the parts supply company 42 when assessing an assessment target will be explained.

First, an assessment target will be determined. As the assessment target, suppose, for example, a cathode ray tube of product number DEF 456 will be assessed. Also, suppose the data on the standard product is already described in the environment assessment table 1 during the maintenance operation.

The user enters a password for the parts supply company to the terminal 28.

The terminal 28 checks the password entered and if the password is proven to be the correct one, the terminal 28 allows the user to perform assessment.

The parts supply company 42 is a company different from the head office 40 and business establishment 41. That is, suppose the parts supply company 42 is another company that supplies parts to the business establishment 41.

The data inputting means 33 of the terminal 28 enters the product number of the cathode ray tube to be assessed first. That is, product number DEF 456 is entered.

Then, the terminal 28 notifies the terminal 27 of the product number of the product to be assessed and requests the server 25 to transfer the environment assessment table 1 used to assess the cathode ray tube of product number DEF456 and the basic data 30 and basic assessment method 31 to calculate the result value of the assessment standard 3 of the environment assessment table 1.

In response to this, terminal 27 notifies the server 25 of the product number of the cathode ray tube to be assessed and requests the server 25 for data necessary for assessment. In response to this, the server 25 transfers the environment assessment table 1 of the cathode ray tube of product number DEF 456, the basic data 30 and basic assessment method 31 to the terminal 27. However, since the password for the parts supply company is already entered in the terminal 28, the terminal 27 does not transfer all these data to the terminal 28, but only transfers data necessary for assessment. Therefore, it is possible to prevent the internal situation of the business establishment 41 from being disclosed to the users of the parts supply company.

The terminal 27 transfers the environment assessment table 1 of the cathode ray tube of product number DEF 456, the basic data 30 and basic assessment method 31 to the terminal 28.

Then, the data inputting means 33 of the terminal 28 enters data necessary to calculate the assessment standard result value of the assessment standard 3 as in the case of the first embodiment.

Here, if all data necessary to assess the assessment standard 3 of the environment assessment table 1 is supplied to the business establishment 41, this means that even the internal situation of the parts supply company 42 is disclosed to the business establishment 41.

On the contrary, if the environment assessment table 1, basic data 30 and basic assessment method 31 are all supplied to the terminal 28, this means that the internal situations of the business establishment 41 and head office 40 are disclosed to the parts supply company 42.

To avoid such problems, the inputting means 33 of the terminal 28 inquires the user of necessary data, for example, in the following question format.

That is, “flow much energy have you consumed?,” “How much CO₂ have you emitted?,” etc. To facilitate answers to these questions, the inputting means 33 presents the user the basic data 30 and basic assessment method 31 as shown in FIG. 2. The user estimates the amount of energy consumption and CO₂ emitted with reference to the basic data 30 and basic assessment method 31.

Thus, since the basic data 30 and basic assessment method 31 to calculate the amount of energy consumption and CO₂ emitted, etc. are supplied, it is possible for all the parts supply company 42, head office 40 and business establishment 41 to calculate these values using a unified method.

The inputting means 33 of the terminal 28 enters necessary data in this way. This method eliminates the need for the user to enter data so far as how much petroleum or how much power the parts supply company 42 has consumed to the terminal 28, thus preventing the internal situation of the parts supply company from being disclosed to the business establishment 41. Moreover, since no data that will disclose the internal situation of the business establishment 41 is transferred to the terminal 28, the internal situation of the business establishment 41 will not be disclosed to the parts supply company 42. As shown above, the environment assessment system 29 of this embodiment can perform environment assessment without mutual internal situations from being disclosed to each other.

Then, the calculating means 34 of the terminal 28 calculates each assessment standard result value from each assessment standard 3 using the environment assessment table 1.

Furthermore, the calculating means 34 calculates assessment points using each assessment standard result value obtained, assessment point standard 5 and weight 4. The calculating means 34 further calculates overall assessment points of different categories such as product body segment assessment 16, production segment assessment 17, packing segment assessment 18, etc. and calculates an overall assessment value over the lifecycle of the cathode ray tube of product number DEF 456.

Finally, the outputting means 35 displays the updated environment assessment table 1 in whole or in part or only assessment points on the monitor of the terminal 27 according to the user's specification and at the same time transfers to the server 27 via the network 24.

The terminal 27 transfers these data to the server 25 and the server 25 stores the assessment result transferred from the terminal 27 as the environment assessment information 32.

Maintenance and assessment are carried out in this way and their results are stored as the environment assessment information 32 of the server 25.

If access permission is given after entering a password from each terminal 26 to 28, the environment assessment information 32, etc. stored in this way can be referenced from the terminal.

For example, if a manager password is entered in any one of terminals 26 to 28, it is possible to access the environment assessment table 1, basic data 30 and basic assessment method 31, data in the deep layer or data for external use of the environment assessment information 32. Likewise, if a password for business establishment assessment is entered, it is possible to access data in the deep layer as well as data for external use. On the contrary, if data of a password for the parts supply company is entered, it is possible to access data for external use but it is not possible to access data in the deep-layer.

In this way, in addition to the effect of the first embodiment, the environment assessment system 29 of this embodiment can perform environment assessment over the lifecycle of the assessment target beyond the bounds of companies while protecting mutual privacy.

By the way, the terminals 26, 27 and 28 of this embodiment are described as have been installed in the head office 40, business establishment 41 and parts supply company 42, respectively, but the present invention is not limited to this. The terminals can also be installed in places other than the head office 40, business establishment 41 and parts supply company 42. A plurality of terminals can also be installed in the same location.

Moreover, the network 24 of this embodiment can also be an intranet or the Internet. As the network 24, a wire circuit can be used or a wireless circuit can be used. Or both can be used simultaneously.

Furthermore, in this embodiment, the right to access the server 25 is expressed with three types of password, but the present invention is not limited to this. The access right can be classified into 4 types and expressed with 4 types of password or the access right can be classified into 5 types and expressed with 5 types of password. In short, all that is required is that the right to access the data stored in the server 25 be clearly defined and passwords be classified according to the right.

Moreover, this embodiment describes the case where the data stored in the server 25 is controlled hierarchically by dividing the data into the deep layer and the layer for external use, but the present invention is not limited to this. Data can be controlled divided into 3 layers or 4 layers and in short, all that is required is hierarchically control data stored in the server 25. Moreover, when data is controlled hierarchically in this way, all that is required is that passwords be distinguished according to the layer to which the access right is applicable.

Furthermore, this embodiment describes the case when the terminal 27 of the business establishment 41 assesses an assessment target, the data inputting means 33 automatically enters data necessary to calculate an assessment standard result value of the assessment standard 3 from the parts list/design drawings 37 sent from the server 25, but the present invention is not limited to this. The data inputting means 33 can also display a GUI screen on a monitor and the user can enter data necessary to calculate an assessment standard result value of the assessment standard 3 using the keyboard or mouse according to instructions on the GUI screen.

Furthermore, in the environment assessment system 25 of this embodiment, the server 25 stores the environment assessment table 1, basic data 30, basic assessment method 31 and environment assessment information 32 and the terminals 26 to 28 use these data as required, but the present invention is not limited to this. A distributed processing system can also be used in which the terminals 26 to 28 share the functions of the server 25.

(Third Embodiment)

Then, a third embodiment will be explained.

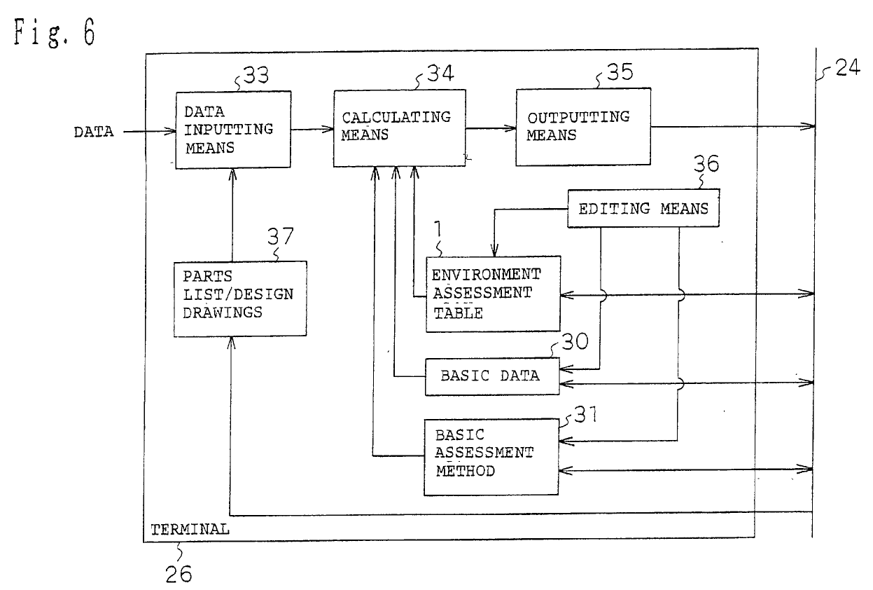

FIG. 7 shows a configuration of an auction system 50 of this embodiment.

The auction system 50 comprises a network 51 with a server 52 and a plurality of terminals 53, 54 and 55 connected thereto. The terminal 53 is installed in a head office 40, the terminal 54 is installed in a business establishment 41, terminal 55 is installed in a parts supply company 42 that manufactures parts making up products manufactured by the business establishment 41 and supplies to the business establishment 41.

To facilitate the understanding, FIG. 7 shows a case where three terminals 53 to 55 are connected to the network 51, but actually the number of terminals 53 to 55 is not limited to 3 and these terminals are installed in a plurality of business establishments and a plurality of parts supply companies.

The auction system 50 is a system that auctions used products whose service life as products or parts has ended or used materials or recycled materials recycled from products whose service life as products or parts has ended.

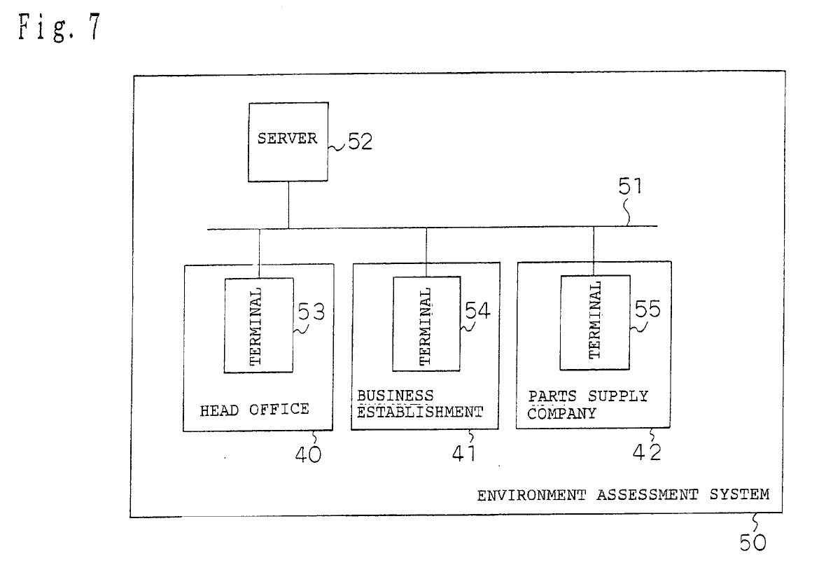

FIG. 8 shows a configuration of the server 52. The server 52 functions as a server in a client server system that collects information on recycled materials, used products and used materials, seller information, which is the auction conditions thereof and buyer information to purchase those products and materials from the terminals 53 to 55 connected to the network 51, auctions those products and materials and notifies the terminals 53 to 55 of the auction results.

The server 52 is configured by auction information collecting means 59, auction means 60 and auction result reporting means 61.

The auction information collecting means 59 is means of collecting seller information and buyer information from the terminals 53 to 55.

The auction means 60 is means of auctioning according to the seller information and buyer information collected.

The auction result notifying means 61 is the means of reporting intermediate results of the auction or final results of the auction as to which terminal has bidden off, etc. to the terminals 53 to 55.

The terminals 53 to 55 are the terminals that participate in an auction as a seller or buyer.

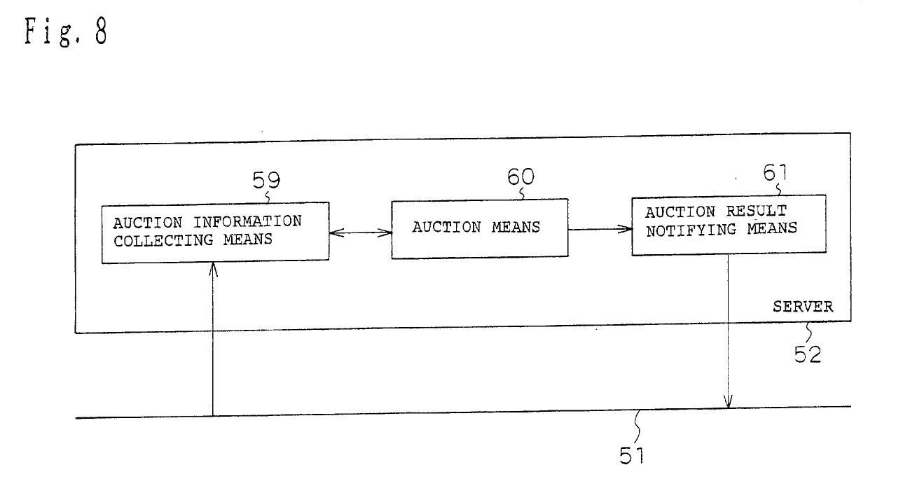

FIG. 9 shows a configuration of the terminals 53 to 55. The terminals 53 to 55 each have an equivalent configuration and are configured by registering means 62, seller information supplying means 63, buyer information supplying means 64 and auction result reporting means 65.

The registering means 62 is means of registering in the server 52 to participate in an auction.

The seller information supplying means 63 is means of notifying the server 52 that the user will participate in the auction as a seller and presenting the server 52 under what conditions the user will sell what kind of products.

The buyer information supplying means 64 is means of notifying the server 52 that the user will participate in the auction as a buyer.

The auction result reporting means 65 is means of reporting the auction results notified from the server to the user using a GUI screen, etc.

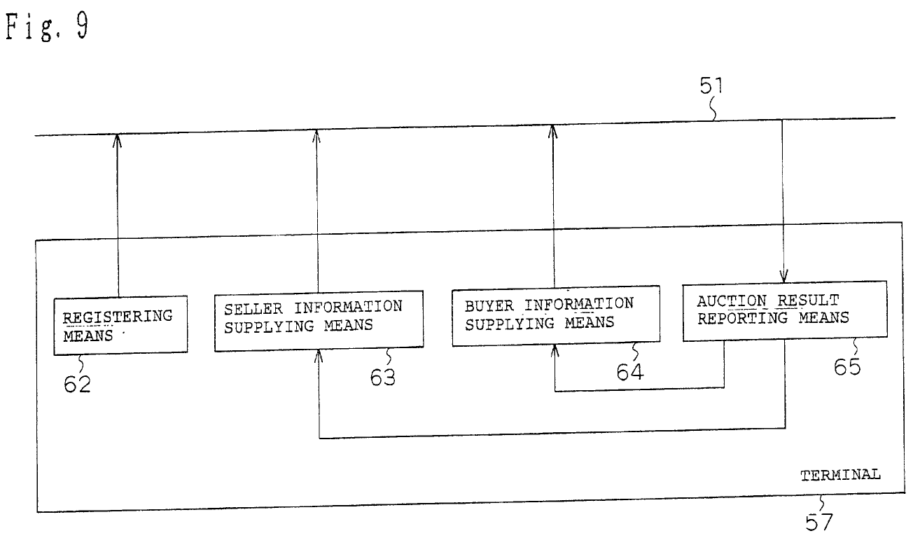

FIG. 10 shows seller information 68. The seller information 68 is configured by auction conditions 66, product or parts information 67.

The auction conditions 66 are conditions to participate in an auction and are made up of a minimum selling price, auction period, auctioned part that specifies, in the case where a used TV set is auctioned, the case of the TV set for example, and quantities to be auctioned, etc.

The product or part information 67 is information on what is to be sold, names of products or parts, quality or environment assessment points explained in the first embodiment and second embodiment.

The product or part information 67 of this embodiment is information of recycled materials or used products or used materials to be presented in the auction of the present invention.

Next, operation of this embodiment will be explained.

To participate in an auction for the first time, it is necessary to register in the server 52 that one will participate in the auction.

The registering means 62 of the terminal 54 notifies the server 52 that the terminal 54 will participate in the auction.

The server 52 determines whether the terminal 54 is the eligible terminal to participate in the auction or not and if the terminal 54 is proved to be the eligible terminal, the server 52 issues a user ID and password to participate in the auction.

Hereinafter, the terminal 54 will be able to participate in the auction by notifying the server 52 of the user ID and password.

Suppose the terminal 52 attempts to sell by auction 50 used TV sets located in the business establishment 41.

Then, the seller information supplying means 63 creates seller information 68 including auction conditions 66 and product or part information 67.

The product or part information 67 also includes the environment assessment points subjected to environment assessment in the first embodiment and second embodiment.

The seller information supplying means 63 supplies the seller information 68 to the server 52.

The auction information collecting means 59 of the server 52 collects the seller information 68 sent from the terminal 54. Then, the auction information collecting means 59 supplies the collected seller information 68 to each of terminals 53 to 55 and collects the buyer information from each of terminals 53 to 55.

The auction means 60 totalizes the buyer information during a period specified by the auction period of the auction conditions 66 and notifies intermediate results of the auction such as the current selling price and the number of terminals participating in the auction to the auction result notifying means 61.

The auction result notifying means 61 notifies the intermediate result of the auction to the terminals 53 to 55.

The auction result reporting means 65 of each terminal 53 to 55 displays the auction intermediate result on a GUI screen, etc.

On the other hand, when the terminal 53 or terminal 55 participates as a buyer, the terminal 53 or terminal 55 creates buyer information with reference to the current buying price and supplies the buyer information to the server 52.

When the auction period passes in this way, the auction means 60 notifies the auction final result such as which terminal has bidden off a TV set at what price to each of the terminals 53 to 55.

The auction result reporting means 65 displays the auction final result on a GUI screen, etc. and charges the terminal that has bidden off the TV set.

In this way, the terminal 54 can sell 50 used TV sets.

When the terminal 54 participates in an auction, the terminal 54 can auction a plurality of recycled materials, used products and used materials simultaneously. Furthermore, the server 52 can also hold a plurality of auctions simultaneously. Moreover, the terminal 54 can participate in an auction as a buyer while participating in the auction as a seller. Then, the seller information and the intermediate results are notified to each of the terminals 53 to 55 in real time. As shown above, since the seller information and intermediate result of the auction are speedily and widely notified to each of the terminals 53 to 55, it is possible to promote reuse of recycled materials, used products and used materials, etc.

Furthermore, when no buyer is found in the auction, the auction conditions 66 are changed and the auction is continued. For example, the minimum sales price is lowered. Or the auction period may be extended so that a buyer appears or quantities or amount to be auctioned are changed. Or the auctioned parts can be changed, for example a case of the TV set may be changed to a cathode ray tube of the TV set as the auctioned part. In this way, the auction conditions 66 can be changed while referencing the intermediate results.

Furthermore, these auction conditions 66 can also be changed as follows. That is, the terminal 54 prepares a plurality of auction conditions 66 and prioritizes those auction conditions 66. Then, the seller information supplying means 63 of the terminal 54 supplies a plurality of prioritized auction conditions 66 to the server 52 at the same time.

The server 52 holds an auction according to the auction conditions 66 with the highest priority and if no buyer is found within a specified time, the server 52 notifies the information to the terminal 54.

In response to this, the auction result reporting means 65 reports to the seller information supplying means 63. The seller information supplying means 63 then instructs the server 52 to change to the auction condition 66 with the second highest priority and hold an auction.

In response to this, the server 52 holds an auction again according to the next auction conditions 66.

Thus, the server 52 repeats auctions by gradually changing to auction conditions 66 with lower priority until the buyer appears. In this way, it is possible to perform auctions in a meticulous manner.

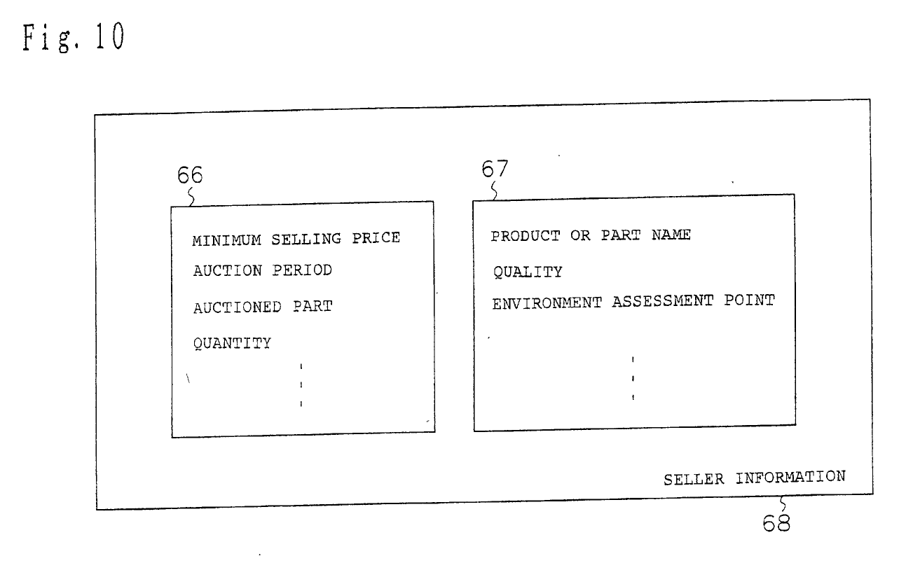

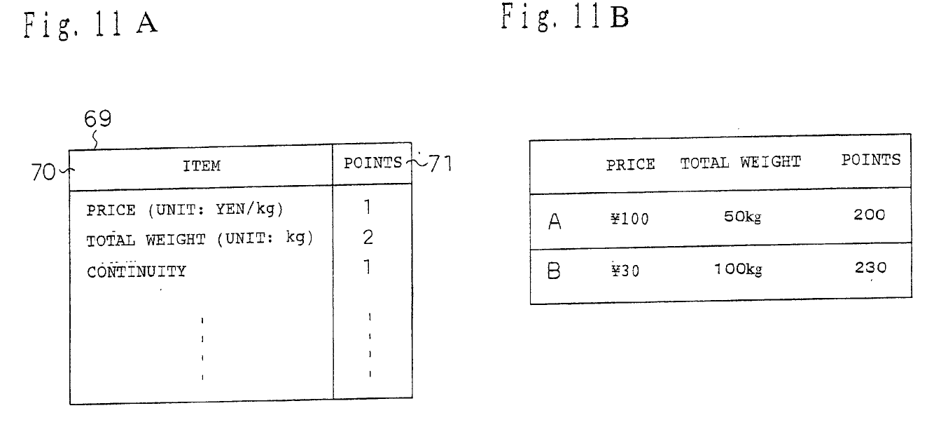

Furthermore, in addition to the auction conditions 66 explained in FIG. 10, the auction conditions 69 of FIG. 11A can also be used.

That is, the terminal 54 adds points 71 indicating what item is prioritized to each item 70 of the auction conditions 69. Then, the seller information supplying means 63 of the terminal 54 supplies the auction conditions 69 and each item 70 of the auction conditions to the server 52 when the terminal 54 participates in the auction.

The server 52 assesses which buyer has the advantage over other buyers when a plurality of buyers satisfies the auction conditions 66.

FIG. 11B shows an example of the assessment.

Suppose the buyer A wants to buy total weight of 50 kg for \100. Also suppose the buyer B wants to buy total weight of 100 kg for \30.

Then, the auction means 60 assesses the buyer A and buyer B with points using points 71 of the auction conditions 69.

The total points of the buyer A are \100×1 point+50 kg×2 points=200 points.

On the other hand, the total points of the buyer A are \30×1 point+100 kg×2 points=230 points.

Since the buyer B has higher total points, the auction means 60 determines that the buyer B has the advantage over the buyer A as a buyer.

Thus, it is possible to determine which terminal from among the terminals 53 to 55 should be the buyer by comprehensively assessing a plurality of items not only recycled materials, used products, used materials and price but also the amount of transaction, period of purchase continuity such as 1 year or 1 month only.

Furthermore, the auction system 50 of this embodiment adds information such as environment assessment points to the seller information 68 or product or part information 67, and therefore it is possible to objectively assess how much load is put on the environment when using the purchased recycled materials, used parts and used materials.

Furthermore, it is also possible to change the registration fee of auction participation and the commissions of auction participation according to the type of the terminal such as the terminal 54 and terminal 55. Therefore, it is possible to flexibly operate the auction system 50.

Using the auction system 50 of this embodiment makes it possible to promote reuse of products and parts whose useful life has ended, which would conventionally only be disposed of, and reduce load on the environment.

The present invention also includes a program recording medium that is computer-readable and records a program and/or data to allow a computer to execute all or some functions of the environment assessment table, environment assessment apparatus, environment assessment system, server apparatus for environment assessment, terminal apparatus for environment assessment and auction system in whole or in part, characterized in that the above-described functions are executed by the above-described computer-read program and/or data in cooperation with the computer.

The present invention further includes a program that is computer-readable and allows a computer to execute all or some functions of the environment assessment table, environment assessment apparatus, environment assessment system, server apparatus for environment assessment, terminal apparatus for environment assessment, auction system in whole or in part, characterized in that the above-described functions are executed by the above-described computer-read program in cooperation with the computer.

Using Possibility of Industrial

As apparent from the above explanations, the present invention can provide an environment assessment table, environment assessment apparatus, environment assessment system, server apparatus for environment assessment, terminal apparatus for environment assessment and program recording medium capable of objectively and comprehensively grasping influences of products on the environment.

The present invention can provide an auction system and program recording medium capable of promoting reuse of a product or part whose useful life has ended and reducing load on the environment.

What is claimed is:

1. An environment assessment table, comprising:
an assessment item field containing predetermined assessment items about a plurality of types of targets of environment-related assessment;
an assessment standard field containing an assessment standard to determine assessment of respective assessment items; and
an assessment point field containing assessment points for various assessment result values determined by said assessment standard.

2. The environment assessment table according to claim 1, wherein said table is provided in a sheet form or whole or part of which can be displayed in a display apparatus and has a blank field that can contain specific numerical values in said assessment standard field about specific targets to be assessed, assessment result values and assessment points obtained in said assessment point field in whole or in part, and said blank field is writable.

3. The environment assessment table according to claim 1 or claim 2, wherein when said environment assessment table is displayed on said display apparatus, restrictions are placed on the display content and the content of said table in whole or in part is displayed according to the authority of a person who displays the table.

4. The environment assessment table according to any one of claims 1 to 3, wherein said assessment item field is classified into at least a product body, production process and packing.

5. The environment assessment table according to any one of claims 1 to 4, wherein basic data and/or a basic assessment method presupposed to determine said assessment standard are also added.

6. The environment assessment table according to any one of claims 1 to 5, wherein said assessment item field contains at least transport assessment during transportation of said target and usage assessment when said target is used and has a field for calculating assessment values over the lifecycle of said target from the assessment values in whole or in part of said assessment item field.

7. An environment assessment apparatus for using one or a plurality of environment assessment tables according to claims 1 to 6, performing assessment on a specific assessment target based on said assessment standard and obtain assessment points from the assessment results, comprising:
assessment standard inputting means of inputting data to calculate said assessment standard for a specific assessment target;
assessment outputting means of assessing said assessment standard and outputting the assessment result using said tables based on the data input by said assessment standard inputting means;
assessment point calculating means of obtaining assessment points from said assessment outputting means using said tables; and
assessment point outputting means of outputting assessment points obtained by said assessment point calculating means.

8. The environment assessment apparatus according to claim 7, wherein said assessment standard inputting means can enter data to calculate said assessment standard from a parts list and/or design drawings of said target.

9. An environment assessment system equipped with a plurality of terminals mutually connected over a network and a single or a plurality of servers connected to the network,
wherein each of said terminals comprises:
calculating means of calculating points of assessment on a predetermined target using the environment assessment table according to any one of claims 1 to 6; and
outputting means of outputting assessment points for said target to a predetermined server from among said servers from the calculation result of the calculating means,
and said server accumulates the environment assessment information obtained.

10. The environment assessment system according to claim 9, wherein said server supplies said environment assessment table to each terminal and also additionally supplies basic data and/or basic assessment method presupposed to determine said assessment standard to each of said terminals.

11. The environment assessment system according to claim 9 or claim 10, wherein said terminal sends information to determine said assessment standard to another terminal using said basic data and/or basic assessment method and said other terminal performs assessment based on said environment assessment table using the information.

12. The environment assessment system according to any one of claims 9 to 11, wherein said terminal can modify, add or delete the content of said environment assessment table received from said server.

13. The environment assessment system according to any one of claims 9 to 12, wherein the data accumulated in said server is stratified and accessible layers vary depending on the level of the right of access to the data.

14. The environment assessment system according to any one of claims 9 to 13, wherein said terminal comprises assessment standard inputting means of inputting data to calculate said assessment standard from said target parts list and/or design drawings and said calculating means calculates said assessment points using said input data.

15. A terminal apparatus for environment assessment connected to a network, comprising:
calculating means of calculating assessment points for a predetermined target using the environment assessment table according to any one of claims 1 to 6; and
outputting means of outputting assessment points for said target to said network from the calculation result from said calculating means.

16. A server apparatus for environment assessment that accumulates at least the assessment points output to a network by a plurality of terminal apparatuses for environment assessment according to claim 15 as environment assessment information.

17. An auction system, comprising:
a plurality of terminals connected to a network; and
a server connected to said network,
wherein said terminal supplies said server with information of recycled materials or used products or used materials to be supplied to an auction and auction conditions thereof, and
said server collects information of recycled materials or used products or used materials sent from said terminal, puts these products for auction according to said auction conditions and then notifies said participating terminal of the result.

18. The auction system according to claim 17, wherein said information of recycled materials or used products or used materials also includes information obtained from the environment assessment apparatus according to claim 7.

19. The auction system according to claim 18, wherein said terminal participating in auction needs to be registered beforehand and commissions vary depending on the type of terminal.

20. The auction system according to any one of claims 17 to 19, wherein said terminal supplies information of recycled materials or used products or used materials to be supplied to said auction and a plurality of auction conditions thereof.

21. The auction system according to any one of claims 17 to 20, wherein said terminal offers said plurality of auction conditions with priority assigned beforehand and when no buyer is found within a predetermined time presented under said auction conditions, changes to said auction condition with lower priority.

22. The auction system according to any one of claims 17 to 21, wherein said terminal offers said auction conditions with priority assigned to each item of said auction conditions,
said server, when an auction is held, assesses conditions presented by terminals to be a buyer with weights assigned according to the priority of said each item of said auction conditions, calculates priority of the terminals to be a buyer and determines whether any one of said terminals participating in said auction has the advantage over other terminals as a buyer.

23. The auction system according to claim 22, wherein said priority means points and said advantage means the total points of assessment result value obtained by assessment for every said item.

24. A program recording medium that records a program and/or data to allow a computer to execute all or some functions of all or some means of the environment assessment table, environment assessment apparatus, environment assessment system, environment assessment server apparatus, environment assessment terminal apparatus or auction system according to any one of claims 7 to 23, wherein said program recording medium is computer-readable.

25. A program that allows a computer to execute all or some functions of all or some means of the environment assessment table, environment assessment apparatus, environment assessment system, environment assessment server apparatus, environment assessment terminal apparatus or auction system according to any one of claims 7 to 23.
